(19) United States
(12) Patent Application Publication
(10) Pub. No.: US 2004/0015262 A1
(43) Pub. Date: Jan. 22, 2004

(54) Method for controlling access to devices in a pervasive embedded environment

(75) Inventors: William A. Brown, Raleigh, NC (US); Richard William Muirhead, Tyler, TX (US); Francis Xavier Reddington, Sarasota, FL (US)

Correspondence Address: Darcell Walker, Suite 250, 9301 Southwest Freeway, Houston, TX, 77074, US

(73) Assignee: INTERNATIONAL BUSINESS MACHINES CORPORATION, Armonk, NY

(21) Appl. No.: 10/199,243

(22) Filed: Jul. 18, 2002

(51) Int. Cl. G06F 19/00

(52) U.S. Cl. 700/207

(57) ABSTRACT

The present invention provides a method to monitor and control the transmission of message across a network that collects and records a unique set of data about devices on the network. The collected data contains information about the operations of a device over a period of time. The data set contains unique status information recorded about that device. In the method of the present invention access control techniques are developed to control device access and message transmission across the network. A set of device privileges is created that define the message transmission capabilities for each device on the system or on the network. The present method detects an attempt by a device on the network to transmit a message across the network. After this transmission attempt detection, there is a determination of whether the transmitting device has the privilege to access and transmit this message to the intended receiving device. When the search does find a privilege, the message transmission is allowed to continue and the message will be received at the designated receiving device. When the search does not find a privilege, the message transmission is terminated and the message will go to the intended receiving device. This method also has the capability to record the message transmission transaction or any message transmission attempt in a repository of the network in a manner similar to the recordation of the status conditions of the devices on the network.

### FIELD OF THE INVENTION

This invention relates to a method to control access to devices located on a network that is capable of monitoring and recording status changes of the devices and in particular the present invention relates to a method for controlling the transmission of messages across the network.

### BACKGROUND OF THE INVENTION

Currently there is an increasing trend to automate various activities and task in our society. Industries such as the banking industry, the automotive industry, the oil and refining industry and the transportation industry use computers and automation to control machines and other various devices during the performance of many tasks and processes. The application of automation control systems has expanded from large industries to small businesses and residential homes.

Home automation systems, or home management systems as they are sometimes called, commonly provide for control of lighting, heating and air conditioning, window shades or curtains, pool heaters and filtration systems, lawn sprinklers, ornamental fountains, audio/visual equipment, and other appliances. Home automation systems are frequently integrated with a home security system so that when a fire alarm is raised, for example, the system will automatically turn on internal and external lights. Security systems frequently include lighting control and other types of home automation as an option. Many larger homes incorporate a home theater that requires a certain amount of automation for convenient operation and this automation is often extended to other parts of the dwelling. In farms, the automation system will also control outbuilding heating and lighting and warn of non-standard conditions in equipment such as automated feeding machinery.

Many different designs exist for automation systems. One form of automation system includes a central control unit that monitors environmental sensors and inputs from user controls and maintains a schedule of preprogrammed time-of-day and day-of-the week events. Inputs to the central control are provided by dedicated low-voltage wiring, for example, from door and window sensors, signals carried on power lines, RF signals, signals on existing telephone wiring and, occasionally, optical signals. The central control unit is controlled by a program that is either specifically built for the particular installation or a general-purpose program with a user interface that allows the owner or a technician employed by the owner to make certain types of modifications. The interfaces to these programs can be anything from strings of digits entered on standard touch-tone keypads, for example, Home Automation Inc.'s Omni Automation and Security System, to graphical user interfaces, for example, the Molex “Choices” software.

The communication between the central control unit and various devices on the system can be through a variety of protocols. The Echelon Corporation has built home automation and industrial control apparatus based on a signaling protocol they refer to as LonWorks that uses a network of nodes each of which has one or more microprocessors. Many systems are designed to operate in a “cooperative computing” environment in which the individual nodes maintain their own programs. Programming of the individual nodes can be done by downloading new software from a temporarily attached lap top computer or by downloading software over the LonWorks network. A similar approach has been taken by CEBus and has been used in many custom installations for larger homes and office buildings. The Consumer Electronics Bus (CEBus) provides the standard for creating products and devices to communicate with each other, and should build intelligence into homes or any physical or virtual facility with smart products (aggregation of smart devices) in anticipating tomorrow's consumer needs.

In a home, there are many appliances/devices that are powered by electricity, either AC or DC. Current technology development is moving in the direction of more automated control of routine tasks performed by the devices. However, in any computer system, even physical facility systems with automated control of facility devices and appliances, there is an inherent security risk when intruders that have malicious purposes can access sensitive or classified information using normal accessing channels. Unauthorized users can cause many problems for computer systems. These users may modify software to cause unwanted events to occur or to benefit themselves. The unauthorized users may also access private or classified data, or copy proprietary software. While doing all this, they can seriously impact all computer-based operations when their use of computer resources causes deterioration of response times or denial of service for legitimate users. Such unauthorized access can be accomplished in a number of ways, for example, the user can claim to be someone else, the user can divert the access path to another computer system, or the user accesses the system before a legitimate user logs off the system.

In addition, access can be gained by persons who observe a legitimate logon session within an open communication network and later masquerade as that legitimate user by using the information seen during the observation. Simple, user-selected and often personally related passwords can be “guessed” by intruders or programs written by the intruders. Legitimate sessions may be recorded from the communication network for later playback or an intruder may “piggyback” a legitimate session by using the system before the user has logged out. To guard against external attacks, computers and computing systems must have internal mechanisms that intercept unauthorized attempts to access the computers and resources in a computing system.

Computer security techniques have been developed to protect single computers and network-linked computer systems from accidental or intentional harm, which can result in destruction of computer hardware and software, physical loss of data, deception of computer users and the deliberate invasion of databases by unauthorized individuals. Computers and the information contained therein are considered confidential systems because their use is typically restricted to a limited number of users. As mentioned, confidentiality and the possession of information can be violated by shoulder surfing, or observing another user's computer screen; tricking authorized users into revealing confidential information; wiretapping, or listening in on or recording electronic communications; and stealing computers or information. A variety of simple techniques currently exist to prevent computer crime. For example, destroying printed information, protecting computer screens from observation, keeping printed information and computers in locked cabinets, and clearing desktops of sensitive documents prevent access to confidential information. Although these basic procedures can insure some minimum level of security, more sophisticated methods are also necessary to prevent computer crimes.

One technique to protect confidentiality is encryption. Information can be scrambled and unscrambled using mathematical equations and a secret code called a key. Two keys are usually employed, one to encode and the other to decode the information. The key that encodes the data, called the public key may be possessed by several senders. The key that decodes the data, called the private key is possessed by only one receiver. The keys are modified periodically, further hampering unauthorized access and making the encrypted information difficult to decode or forge.

Another technique to prevent computer crime is to limit access of computer resources to approved users. In order to implement a security policy controlling the exchange of information through a personal computer or throughout a computing system, some mechanism has to exist for uniquely identifying each user of the network system. Only in this manner can there be a determination and control of the access rights of each system user. This process of identifying and verifying a “principal” (e.g., a user) on the network is known as “authentication.” Access-control software verifies computer users and limits their privileges to view and alter files. Records can be made of the files accessed, thereby making users accountable for their actions. Military organizations give access rights to classified, confidential, secret, or top-secret information according to the corresponding security clearance level of the user.

The use of passwords to authenticate users is the most prevalent means of controlling access currently in use. In many cases, the users select their own passwords or continue to use the group password. Studies have shown that most users select passwords that are easy to remember, generally personal in nature and seldom change them. Under these circumstances, passwords are easy to guess either by a motivated individual or a simple program using a random word generation technique. Some systems may use an authentication means such as requesting the user to supply a sequence of names, etc. in conjunction with a password. This makes entry more difficult but is still vulnerable if the logon procedure is observed and the response identified or the expected response is easy to guess.

It is desirable to provide an automated system that has a central control unit that can monitor and record the operational history of devices on that system. It is another desire to have a means to that can control the transmission of messages across this system and can control access to any device on the system. It is also desirable for the system to be able to terminate unauthorized message transmissions and to record message transmissions and transmission attempts.

### SUMMARY OF THE INVENTION

It is an objective of the present invention to provide a method to monitor and record the operation of devices in a network environment such as a physical facility.

It is a second objective of the present invention to provide a method that can control the transmission of messages on the network that monitors and records the status of devices on the network.

It is a third objective of the present invention to provide a method that can control the access to devices on a network that monitors and records the status of devices on the network.

It is a fourth objective of the present invention to provide a method that records message transmissions and transmission attempts across network that monitors and records the status of devices on the network.

It is a fifth objective of the present invention to provide a method to assign transmission privileges to devices on a network that monitors and records the status of devices on the network.

The present invention provides a method to monitor and control the transmission of message across a network that collects and records a unique set of data about devices on the network. The collected data contains information about the operations of a device over a period of time. The data set contains unique status information recorded about that device. In particular, the data set will have an entry for each status change of the device that occurs over a determined period of time.

In the method of the present invention, access control techniques are developed and applied to control message transmissions across the network that monitors and records the status conditions of devices on the network. A set of device privileges is created that define the messages transmission capabilities for the devices on the network. The present method detects an attempt by a device on the network to transmit a message across the network. The method first identifies the device attempting to transmit the message. After this identification, there is a determination of whether the transmitting device has privilege to access and transmit this message to the receiving device. This privilege determination step can involve searching a list of privileges assigned to the transmitting device to find a privilege that covers this particular type of message transmission. When the search does find a privilege, the message transmission is allowed to continue and the message will be received at the designated receiving device. The method of the present invention also has the capability to terminate a transmission attempt if the transmitting device does not have a privilege that covers the transmission of the message to the designated receiving device. This method also has the capability to record the message transmission transactions in a repository in a manner similar to the recording of the status conditions of the devices.

### BRIEF DESCRIPTION OF THE DRAWINGS

FIG. 1 is a configuration of components in a physical facility that implements the method and system of the present invention.

FIG. 2 represents the application of the present invention to a thermostat system.

FIG. 3 illustrates a state diagram showing the state management of a CAL message compliant device.

FIG. 4 is an illustration of a security system of the present invention that has the ability to control access to devices in a system that monitors, controls and stores status information of the devices in the system.

FIG. 5 is a flow diagram of the steps in the method of the present invention.

FIG. 6 is an illustration of message transmission record in accordance with the security system of the present invention.

### DETAILED DESCRIPTION OF THE INVENTION

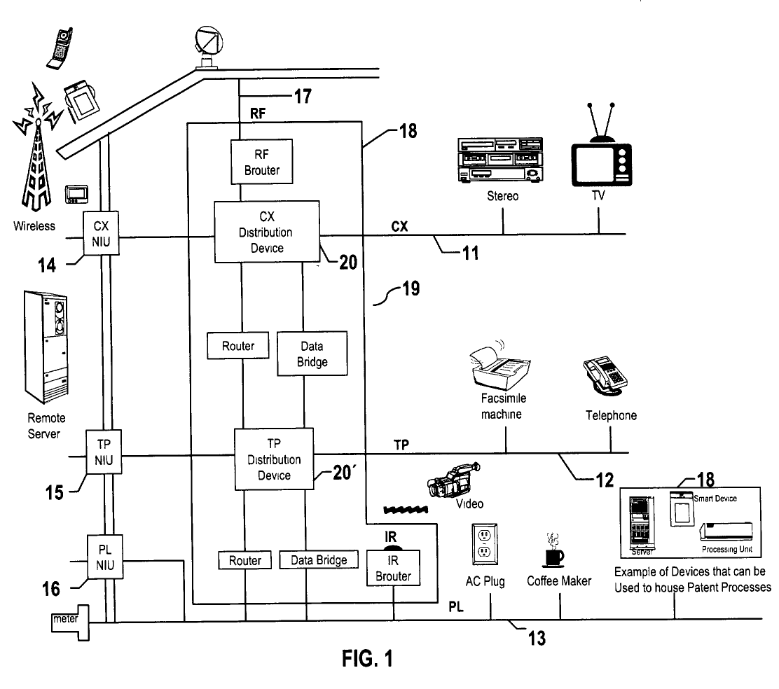

The present invention provides a method to control access to devices located on a network that is capable of monitoring and recording status changes of the devices. In order to clearly illustrate the techniques in this invention, the description of the embodiment for this invention will be in the context of an application in a physical facility. However, the application of this invention encompasses other alternate embodiments in addition to the physical facility environment described herein. FIG. 1 is a configuration of components in the system of the present invention. In this configuration lines 11, 12 and 13 are various ways that energy can enter a facility to enable operations of the devices in the facility. Line 11 represents communications over a coaxial cable through a device such as a television set. Line 12 represents communications over twisted pair cables through a device such as a telephone. Line 13 represents the supply of energy through a standard power line wired into the facility to operate devices and appliances in the facility such as a coffee maker. These communication lines are physical and therefore have a physical entry into the facility. The physical entry points for the coaxial cable, twisted pair and power lines are represented by NIU boxes 14, 15, and 16 respectively. Also shown is an input medium using radio frequencies (RF) 17. Devices that communicate through this medium are remote devices/wireless devices that include devices such as cellular telephones. In the present invention, there would be a status of each device in facility regardless of the manner in which the device is powered or the manner in which the device communicates. The center of the activity for this network is the state manager 18, which is a process that receives information from various types of devices. This state manager process 18 captures status information for the various devices and coordinates communications between the various devices in the facility. In addition, this process, using industry standard format, provides persistence to a data store and can transmit data to any device in the facility. Section 19 illustrates bridges and routes that provide communication links between the incoming information lines (11, 12, and 13), the distribution devices 20 and 20′ and the network devices

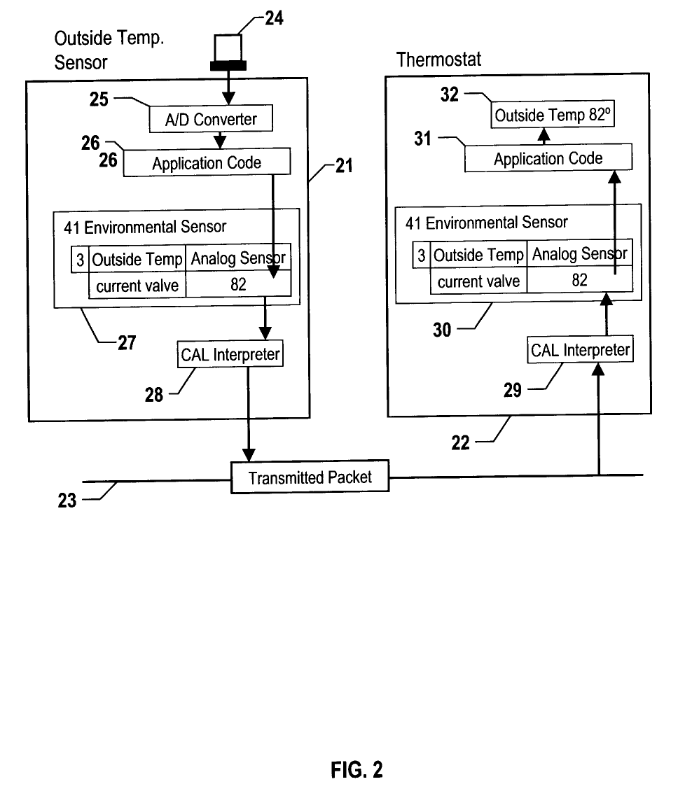

FIG. 2 represents the application of the present invention to a thermostat system. As shown, there is a temperature sensor 21 and an internal thermostat 22. In operation, the temperature sensor detects the temperature and sends this information via the central controller to the thermostat. Depending on the detected temperature at the sensor, the thermostat can adjust the internal temperature by activating a heating or cooling unit. The sensor and thermostat can communicate with the state manager process 18 over a transmission bus 23. The outside temperature system comprises an actual sensor 24 that detects the current outside temperature. This sensor sends an analog signal of the measured to temperature to an A/D converter 25 that converts the signal to digital form. The application code box 26 processes this signal and sends it to a display 27. This application code box 26 contains standard software that can exist on any device. The use of a Consumer Electronic Bus (CEBus) protocol allows for application software to reside on each device. Box 27 displays the current temperature measured by the sensor 24. The Common Application Language (CAL) interpreter 28 receives this measurement and transmits the information via the transmission bus 23 to the state manager 18. This information would be recorded for the temperature sensor in a storage location each time the temperature sensor detected a change in temperature. The internal thermostat 22 contains a Common Application Language (CAL) interpreter 29 to facilitate communication via the transmission bus 23 with the state manager. Also contained in the thermostat is a temperature display 30 similar to the display 27 in the outside temperature sensor 21. Application code 31 puts the temperature information in a form for the temperature display 32. In accordance with the present invention, upon receiving the change in temperature notification from the temperature sensor, the state manager 18 can send a temperature change notification to the thermostat of the new sensed temperature. The thermostat can then adjust the room or facility based on the new sensed temperature. This thermostat changed will then be broadcast/sent to the state manager 18 and recorded as a change in status of the thermostat.

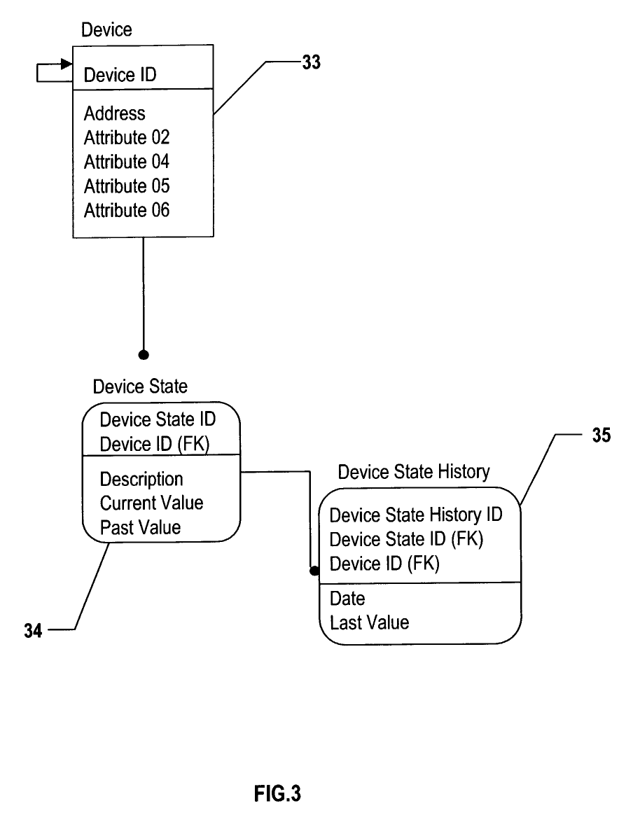

FIG. 3 illustrates a process and data flow model of a state management system of the present invention. It maintains state (status) information of all devices, sensor and components that it can communicate on the system. This model provides the basis and core of sub systems status (state) transition and event driven based decision-making operation. It maintains current status of devices and it's past state history. It also offers the capacity to reset status in the event of an interruption in power or reversing an updating entry. The names chosen in this model exemplify distinctly what the process flow represents. Regardless, if the entities and its attributes are renamed or represented in a de-normalized fashion. The effect of the model is the same. The device 33 comprises attributes 34 that define it current data values, and primary event driven operations. Devices can also be an aggregation of smaller devices (i.e. sensors, components, etc.) The device has a Unique Identifier and sensor(s) or component(s) that are aggregated make up that device [i.e. a thermal sensor, and a Thermostat (consists of thermal sensor, LED display etc.) are both considered devices. Though one attribute may be part of the composition of another.] The device state 35 represents current status configuration of the device. This device state comprises: 1) Device State ID is a unique identifier of the specific status state it references, 2) Description is a clear definition of the State that is identified by the Device State ID, 3) Current Value is a current status value of the device and 4) Past Value is the previous status value of the device. The Device State History 36 contains the history of pass values per device, which include: 1) Date is the date of historical record and 2) Last Value is the last value recorded on that date.

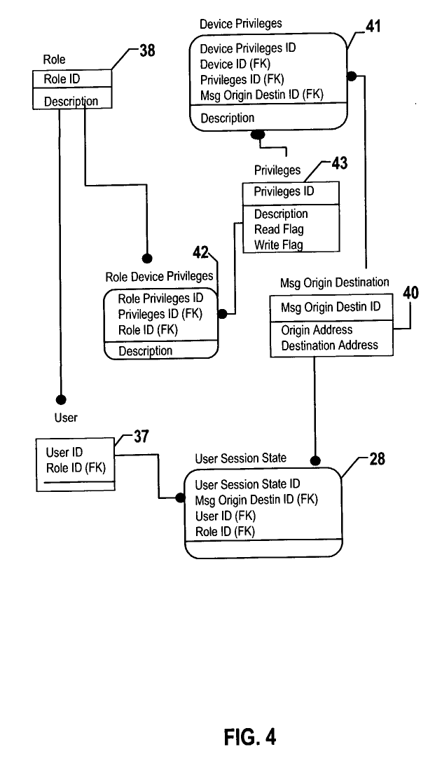

FIG. 4 illustrates a configuration for components of a security model that can be used in the context of a device status reporting system for use in a physical facility as described in a co-pending U.S. application AUS920020055, assigned to the same assignee as the present invention. The security model can work in conjunction with the state manager 18. The security system defines what devices a particular user to in the system can access when attempting to access and communicate with each device in the system. The components of the security system include users 37, roles 38, user session state information 39, message origin and destination 40, device privileges 41, role device privileges 42, and privileges 43.

The user 37 can be defined as a person, system, process, device manufacturer or any other entity that has the ability to transmit messages across the system. The user ID uniquely identifies the user (person, system, process, manufacturer, etc.) Each person is assigned a security role. A role 38 is assigned privileges from zero, one or many devices per device attribute. A role could be a systems administrator. The role ID uniquely identifies the specific role assigned to a user. A system administrator or other user would have a given user identity and assigned role. Each user has a session state 39 that tells the security system the activity of a user at any particular time. The user session state associates a user with access to a device for the duration of an approved message transaction. The user session ID uniquely identifies the user session state record. The message origin destination 40 controls the entrance of a message into the system. This element serves to protect the system from unauthorized entrance into the system similar to a firewall function. Message units contain the delivery address of devices on the network. These delivery addresses are used for auditing purposes. A message origin destination ID uniquely identifies the message origin destination record. The origin address identifies the source of the sender of the message. The destination address identifies the intended destination of the message.

Each user can have device privileges allocated to it for each device to enable the user to control that device. A device privilege 41 can contain one or more groups of privileges. The groups of privileges can be made up of one or more roles. A user that is a role of system administrator would have more privileges for a device than a user that has a role as an air conditioning engineer for that same device. In the example of an air conditioning system, the system administrator would have privileges change settings, adjust temperature controls or to perform any function the administrator desires. However, the engineer would have privileges that would only allow the engineer access to the air conditioner unit for the purpose of performing some maintenance activities. The engineer would not have the privilege to adjust the temperature controls for the air conditioner unit. In FIG. 4, the role device privileges box 42 are assigned privileges in a device associated with a defined role. The role device ID identifies that specific role. The description is a clear definition of what that Role Privilege of that device means as it categorized by it usage (i.e. maintenance is allowed on the device.). Device privileges 41 are a group of actions that can be performed by a device on the system. In an example, the actions for a videocassette recorder can be ‘play’, ‘record’, ‘fast-forward’, ‘rewind’, ‘stop’ and ‘eject’. Privileges 43 are the actions of the device (device privileges) that can be changed on a device. The privilege ID uniquely defines the definition. In many cases all of the device actions would be privileges. As previously stated, the role device privileges are the privileges that are available to a particular type of user (role).

With reference to the present invention, the activities of the security system would also be recorded at the state manager 18. Anytime a message is sent from one device to another device, there would a security check to determine whether that particular communication is within the defined privileges of the sending and receiving devices. Each security check could be recorded. In the alternative, there could be a recording of security checks only for specific types of devices. Each message sent or received by a device would have a corresponding record in the storage location that would contain the origin of the message, the destination of the message and the type of message content. This data would be collected, recorded and stored in a manner similar to the status change data for each device on the system. Analysis performed on the security data could show various types of users and the types of activities that are occurring on the system for a specified time period.

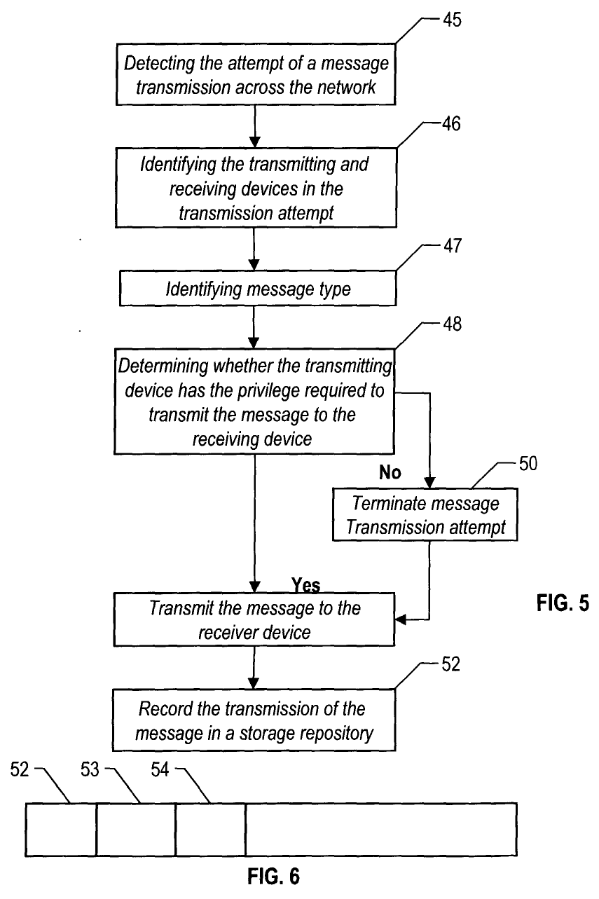

FIG. 5 illustrates the steps involved in the implementation of a security system in accordance with the present invention. During the transmission of a message between devices in accordance with the configuration in FIG. 1, step 45 detects a transmitted message on the network. Step 46 intercepts the message during the transmission. As part of the interception process, there is an identification of the transmitting device and receiving device. FIG. 6 illustrates a message format in which the message contains fields with transmission and receiving device fields 52 and 53. Step 47 examines the message record and determines the type of message indicated in field 54. In an example, the type of message could be device change status message transmitted from a device the central controller. This type of message would be the most common transmitted over the network. Another type of message could be a common from a user to change an attribute of a device on the network. The type of message could also be a command for the receiving device to perform some function. In an example, if the receiving device is a videocassette recorder (VCR), the command could be ‘stop’ if the VCR is operating or ‘start’ if the VCR is currently not playing. Each of the fields 52, 53 and 54 could be in header fields of the transmitted message.

Once there is a determination of the transmitting and receiving devices and the message type, step 48 determines whether this transmission is an allowable transmission. During this step, there is an examination of the role assigned to the transmitting device and the privileges for that role. One determination will be whether the transmitting device has a privilege to access the receiving device. If the transmitting device does have privilege to access the receiving device, the next determination is whether the transmitting device has a privilege to transmit the type of message that is in the present transmission. In an example, one device may have the privilege to access a second device, but the device may only have read privileges. In this case, the device could not send any message that could result in writing information to the receiving device. If the transmitting device does have the appropriate privileges, step 50 permits the message transmission to continue. If the transmitting does not have the appropriate privileges, then the message transmission is terminated and the message is deleted from the system. Whether the message transmission is completed or aborted, a record of this transmission attempt is stored in the device status repository 51 for the system.

With reference to the present invention, the activities of the security system would also be recorded in the same manner as device statuses and in the same storage locations. Anytime a message is sent from one device to another device, there would a security check to determine whether that particular communication is within the defined privileges of the sending and receiving devices. Each security check could be recorded. In the alternative, there could be a recording of security checks only for specific types of devices. Each message sent or received by a device would have a corresponding record in the storage location that would contain the origin of the message, the destination of the message and the type of message content. This data would be collected, recorded and stored in a manner similar to the status change data for each device on the system. Analysis performed on the security data could show various types of users and the types of activities that are occurring on the system for a specified time period.

The present invention provides a method to control access to devices located on a network that is capable of monitoring and recording status changes of the devices. The nature of the application of the present invention is such that various configurations of this invention can be implemented under the same concept described herein. While the description herein is one embodiment of the invention, alternate embodiments can be designed by those skilled in the art that would also fall under the scope of the present invention. It is important to note that while the present invention has been described in the context of a fully functioning data communication system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for controlling the transmission of messages on a network that has the capability to record status changes in the operation of devices on the network, the controlling method comprising the steps of:
defining the conditions under which a device can transmit a message across the network;
defining the types of messages a device can transmit across the network; and
defining the destination devices on the network to which a device can transmit messages.

2. The method as described in claim 1 further comprising the step of determining the attributes of a device that can cause status change in the device.

3. The method as described in claim 2 further comprising the step of determining the conditions under which a change in one or more attributes will cause a status change in the device.

4. A method for controlling the access to devices on a network capable of recording status changes in the operations of the devices, the controlling method comprising the steps of:
defining a set of categories for devices on the network, said categories being defined based on different message transmission privileges across the network;
determining the transmission privileges for each category of devices; and
assigning each device on the network to a device category such that a device in a particular category can only transmit messages across the network according to the message transmission privileges for that category of device.

5. The method as described in claim 4 further comprising the step of determining the types of message transmissions that can occur across the network.

6. The method as described in claim 4 further comprising the step of determining the types of devices on the network.

7. The method as described in claim 4 wherein the transmission privilege determination step further comprises the step of determining the conditions under which each category of device can transmit a message across the network and the type of message a device in a category can transmit.

8. A method for controlling the transmission of messages on a network that has the capability to record status changes in the operation of devices on the network, the controlling method comprising the steps of:
detecting a message transmission across the network;
identifying the device on the network from which the message transmission originated;
determining whether the message transmitting device has the appropriate privilege to transmit the message to the receiving device; and
allowing the transmission of messages across the network that originate from a device that has the appropriate privilege to transmit the message to the receiving device.

9. The method as described in claim 8 further comprising after said device identification step the step of identifying the receiving device for the transmitted message.

10. The method as described in claim 9 wherein said privilege determination step further comprises the step of identifying the privileges for the transmitting device and comparing this message transmission to the identified privileges to determine whether the transmitted message is covered by one of the identified privileges.

11. The method as described in claim 9 further comprises the step of determining the type of message being transmitted across the network by the transmitting device.

12. The method as described in claim 11 wherein said privilege determination step further comprises determining the whether the transmitting device is allowed to transmit messages to the receiving device.

13. The method as described in claim 12 wherein said privilege determination step further comprises after there has been a determination that the transmitting device has the required privilege to transmit messages to the receiving device, the step of determining whether the transmitting device is allowed to transmit the type of message in the present transmission.

14. The method as described in claim 12 further comprising the step of terminating the transmission after there has been a determination that the transmission device does not have the privilege to transmit a message to the receiving device.

15. The method as described in claim 13 further comprising the step of terminating the transmission after there has been a determination that the transmission device does not have the privilege to transmit the message type of the present transmission to the receiving device.

16. The method as described in claim 8 further comprising the step of recording the transmission of the message in a repository on the network.

17. The method as described in claim 14 further comprising the step of recording the failed message transmission attempt in a repository on the network.

18. The method as described in claim 15 further comprising the step of recording the failed message transmission attempt in a repository on the network.

19. A computer program product in a computer readable medium for controlling the transmission of messages on a network that has the capability to record status changes in the operation of devices on the network, the controlling method comprising:
instructions for detecting a message transmission across the network;
instructions for identifying the device on the network from which the message transmission originated;
instructions for determining whether the message transmitting device has the appropriate privilege to transmit the message to the receiving device; and
instructions for allowing the transmission of messages across the network that originate from a device that has the appropriate privilege to transmit the message to the receiving device.

20. The computer program product as described in claim 19 further comprising after said device identification instructions, instructions for identifying the receiving device for the transmitted message.

21. The computer program product as described in claim 20 wherein said privilege determination instructions further comprise instructions for identifying the privileges for the transmitting device and comparing this message transmission to the identified privileges to determine whether the transmitted message is covered by one of the identified privileges.

22. The computer program product as described in claim 20 further comprises instructions for determining the type of message being transmitted across the network by the transmitting device.

23. The computer program product as described in claim 20 wherein said privilege determination instructions further comprise instructions for determining the whether the transmitting device is allowed to transmit messages to the receiving device.

24. The computer program product as described in claim 23 wherein said privilege determination step further comprises after there has been a determination that the transmitting device has the required privilege to transmit messages to the receiving device, the step of determining whether the transmitting device is allowed to transmit the type of message in the present transmission.

25. The computer program product as described in claim 23 further comprising instructions to terminate the transmission after there has been a determination that the transmission device does not have the privilege to transmit a message to the receiving device.

26. The computer program product as described in claim 24 further comprising instructions to terminate the transmission after there has been a determination that the transmission device does not have the privilege to transmit the message type of the present transmission to the receiving device.

27. The computer program product as described in claim 19 further comprising instructions for recording the transmission of the message in a repository on the network.

28. The computer program product as described in claim 25 further comprising instructions for recording the failed message transmission attempt in a repository on the network.

29. The computer program product as described in claim 26 further comprising instructions for recording the failed message transmission attempt in a repository on the network.
